(19) United States
(12) Patent Application Publication
(10) Pub. No.: US 2016/0014190 A1
(43) Pub. Date: Jan. 14, 2016

(54) LINK PER IMAGE

(71) Applicant: POWERINBOX LTD, Petach Tikva (IL)

(72) Inventor: Ohad Sheory, Yehud (IL)

(21) Appl. No.: 14/793,787

(22) Filed: Jul. 8, 2015

Related U.S. Application Data
(60) Provisional application No. 62/021,758, filed on Jul. 8, 2014.

(51) Int. Cl. H04L 29/08; H04L 12/58; H04L 29/06; G06F 3/0482; G06F 3/0484

(52) U.S. Cl. CPC H04L 67/02; G06F 3/0482; G06F 3/04842; H04L 67/42; H04L 51/08

(57) ABSTRACT

A method for allowing a user to select a specific static image displayed within a non-static image such as a video, animation, or slide show, and to receive a network link to the selected static image. The specific static image selected by the user is determined by timing considerations based on the time of the user's selection relative to the start time of the non-static display. Refinements to the method include taking network and processing delays into account and allowing for the display of non-static images that are cached as well as downloaded.

### REFERENCE TO RELATED APPLICATIONS

This application claims benefit of U.S. Provisional Patent Application Ser. No. 62/021,758, filed Jul. 8, 2014, entitled “Link per image”, the disclosure of which is hereby incorporated by reference and the priority of which is hereby claimed pursuant to 37 CFR 1.78(a) (4) and (5)(i).

### BACKGROUND

Internet users often desire links to images on embedded within websites, e-mail messages, or other networked applications and content. In many cases, users may wish to embed links to images within content they intend to make available on the World Wide Web, within e-mail messages, or within other networked applications. In other cases, users may wish to embed links to images in other forms of electronic content.

Links to static images embedded within websites, e-mail messages, or other networked applications and content are easily obtained by users. However, non-static images, such as videos, animations (e.g., Graphics Interchange Format, or GIF), slideshows, and other collections of time-varying images present a special challenge, because links, if available, are typically to the entire collection (e.g., an entire GIF file), rather than to specific individual images of the collection.

It would thus be desirable and advantageous to have a method for linking specific individual images of a non-static collection of images. This goal is met by the present invention.

### SUMMARY

Embodiments of the present invention provide for setting multiple network links to static images in non-static collections of images, wherein the static images are stored in non-transitory storage accessible over the network according location information contained in the network links. Other embodiments of the present invention provide for a user to select (e.g., by clicking or tapping) a specific image of a collection of images in a non-static image embedded within a website, e-mail message, or other networked application or content. These embodiments provide a method for remotely identifying which specific individual image of the collection of images in a non-static image was selected by the user, after which a network link to the selected static image is sent to the user, corresponding to the selected static image of the non-static image. In another embodiment of the present invention, the user who clicks (or double-clicks) on a particular static image of a non-static image is immediately directed to a network address associated with that particular static image.

### DEFINITIONS

The term “static image” herein denotes an image which appears to remain constant and non-changing to the user.

The term “non-static image” herein denotes an image which changes over time in a manner perceptible to the user. A non-static image contains a collection of static images, wherein the individual specific images of the collection are displayed to the user in substantially the same visual location (including a slowly-moving location), and such that the specific individual image displayed changes over time in a manner perceptible to the user. Non-limiting examples of non-static images include: videos, motion pictures, and the like; animations, including computer animations; slide shows; and computer files, such as Graphics Interchange Format (GIF) files with embedded multiple images, which when viewed by a suitable viewing application, display non-static images. For videos, motion pictures, and certain animations, the collection of static images contained within the non-static image includes the individual “frames” (static images) of the non-static image. In certain formats (e.g., the MPEG-X digital video formats) the frames are contained in a single computer file. Certain other file formats (e.g., GIF) can contain multiple static images with data for outputting a non-static image (e.g., a time delay for display of a static image before displaying the next static image). In slide shows, the individual static images (the “slides”) are typically contained in individual computer files and are displayed in sequence by an appropriate application.

The term “static image select” herein denotes a user action by which a particular static image is selected by the user from among a set of time-sequenced static images in a non-static image. A static image select is a special case of a user identification action or a user request to receive related data to a specific item, and can be initiated by user actions including, but not limited to: a screen cursor click, such as a button press via a pointing device such as a mouse, trackball, or touchpad, when the screen cursor is on a particular item; a tap of a finger on a particular item on a touchscreen; a “hover”, a stationary holding of a screen cursor or a finger on a touchscreen over a particular item for at least a predetermined time duration, without a screen cursor click or tap; or any predefined gesture that accomplishes a selection of a static image within a non-static image.

Accordingly, there is provided by an embodiment of the present invention a method for identifying a static image selected by a user from within a display of a non-static image, the method comprising: (a) downloading, to a client device, a non-static image containing a plurality of static images; (b) obtaining a start time of the display of the non-static image; (c) receiving, from the client device, a notification of a selection, by a user, of a static image from the plurality of static images; (d) obtaining a time of the static image selection by the user; and (e) responsively to the obtaining a time of the image, identifying the specific static image selected by the user from the plurality of static images, wherein the identifying is based on the start time of the display of non-static images and the time of the static image selection by the user.

In addition, there is provided by another embodiment of the present invention, a method for identifying a static image selected by a user from within a display of a non-static image, the method comprising: (a) receiving an e-mail message open request from a client device; (b) obtaining a time of opening the e-mail message; (c) receiving, from the client device, a notification of a selection, by a user, of a static image from the plurality of static images without receiving a request for a non-static image; (d) computing a start time of the display of non-static images based on the time of opening the e-mail message; (e) obtaining a time of the static image selection by the user; and (f) responsively to the obtaining a time of the image, identifying the specific static image selected by the user from the plurality of static images, wherein the identifying is based on the start time of the display of non-static images and the time of the static image selection by the user.

### BRIEF DESCRIPTION OF THE DRAWINGS

The subject matter disclosed may best be understood by reference to the following detailed description when read with the accompanying drawings in which:

FIG. 1 conceptually illustrates a network environment and data flow according to an embodiment of the present invention.

FIG. 2 illustrates a data structure of a non-static image according to an embodiment of the present invention.

FIG. 3A is a flowchart of a method according to an embodiment of the present invention.

FIG. 3B illustrates a structure for link data, according to an embodiment of the present invention.

FIG. 3C is a flowchart of a method according to an alternative embodiment of the present invention, utilizing the structure for link data as illustrated in FIG. 3B.

FIG. 4 is a flowchart of an enhancement of the method of FIG. 3A according to another embodiment of the present invention.

FIG. 5 is a flowchart of a modification of the method of FIG. 3A for cached non-static images according to a further embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

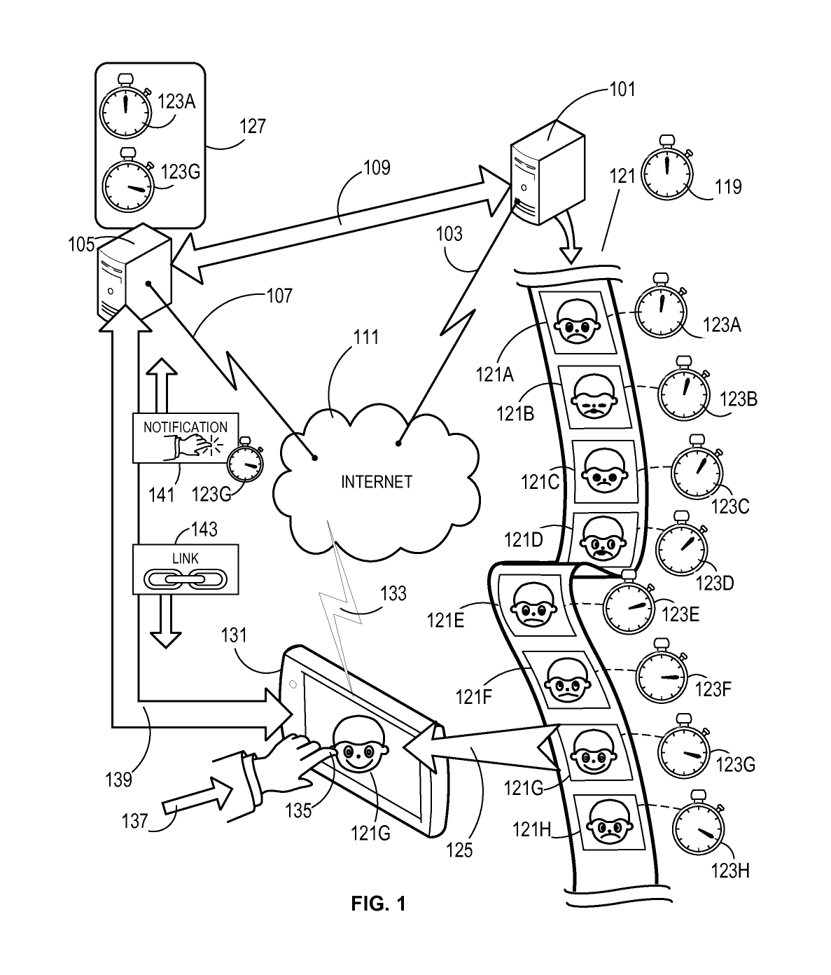

FIG. 1 conceptually illustrates a network environment and data flow according to an embodiment of the present invention. A content server 101 connected via a link 103 to the Internet 111 provides a non-static image 121 to a client device 131 which is connected to Internet 111 via a link 133. Non-static image 121 includes a time series of static images 121A, 121B, 121C, 121D, 121E, 121F, 121G, and 121H for display on client device 131.

Content server 101 begins the transmission of non-static image 121 at a time 119, such that static images 121A, 121B, 121C, 121D, 121E, 121F, 121G, and 121H are displayed on client device 131 at times 123A, 123B, 123C, 123D, 123E, 123F, 123G, and 123H respectively. These display times are nominally the start time of the display of the respective static image. Times, such as times for the start and end of a display, may be expressed in absolute terms, such as by a time-stamp, or may be relative times which are relative to a specified reference time.

The user of client device 131 desires a link to one of the static images of non-static image 121 and selects static image 121G by a tap 137 of a finger 135 on the touchscreen of client device 131 when static image 121G is being displayed. According to this particular embodiment, this user action causes client device 131 to send a notification 141 containing time 123G when the user to a service server 105, which has reference to the times at which static images 121A, 121B, 121C, 121D, 121E, 121F, 121G, and 121H are individually displayed on client device 131. Thus, service server has times 127 available, and when the user initiates tap 137, time 123G is used by service server 105 to identify static image 121G as the static image on which the user tapped. In an embodiment of the invention, the beginning display time of the most recently-displayed image is taken as the time of tap 137. In response to receiving notification 141 and identifying static image 121G as the static image on which the user tapped, service server 105 sends a link 143 to client device 131. Link 143 is to static image 121G, which the user selected. Service server 105 has a virtual link 109 to content server 101, which gives service server 105 access to non-static image 121 and static images 121A, 121B, 121C, 121D, 121E, 121F, 121G, and 121H so that service server 105 can reference times 123A, 123B, 123C, 123D, 123E, 123F, 123G, and 123H and obtain data for link 143.

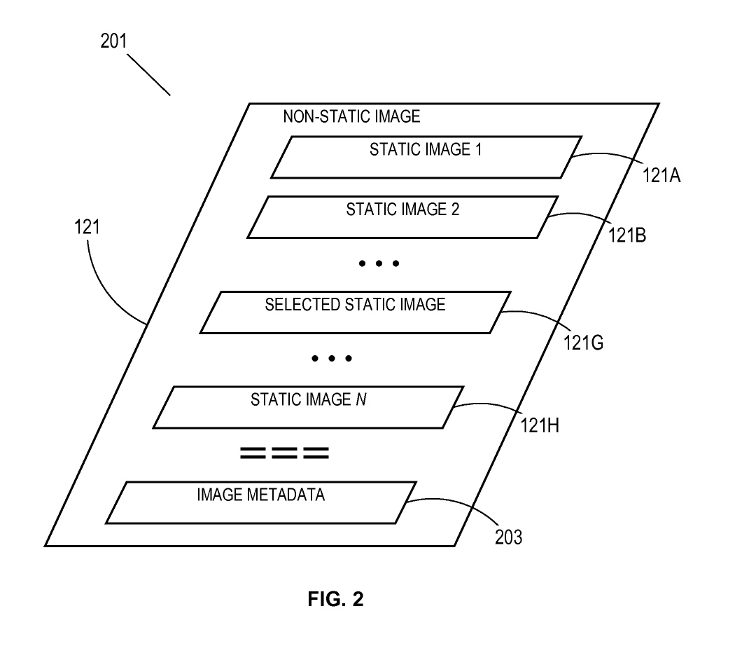

FIG. 2 illustrates a data structure 201 of non-static image 121 according to an embodiment of the present invention. As shown before, non-static image includes static images 121A, 121B, 121C, 121D, 121E, 121F, 121G, and 121H, where static image 121G is a selected static image, as selected by the user during display of non-static image 121 on client device 131 (FIG. 1). In addition, data structure 201 also includes within non-static image 121 image metadata 203. According to certain embodiments of the invention, metadata 203 can contain information including, but not limited to: text, such as descriptive text of the image; copyright information; details of the image source, such as creator or originator, created date, and the like; and image parameters, such as frame rate for animations or image display interval time for slide shows.

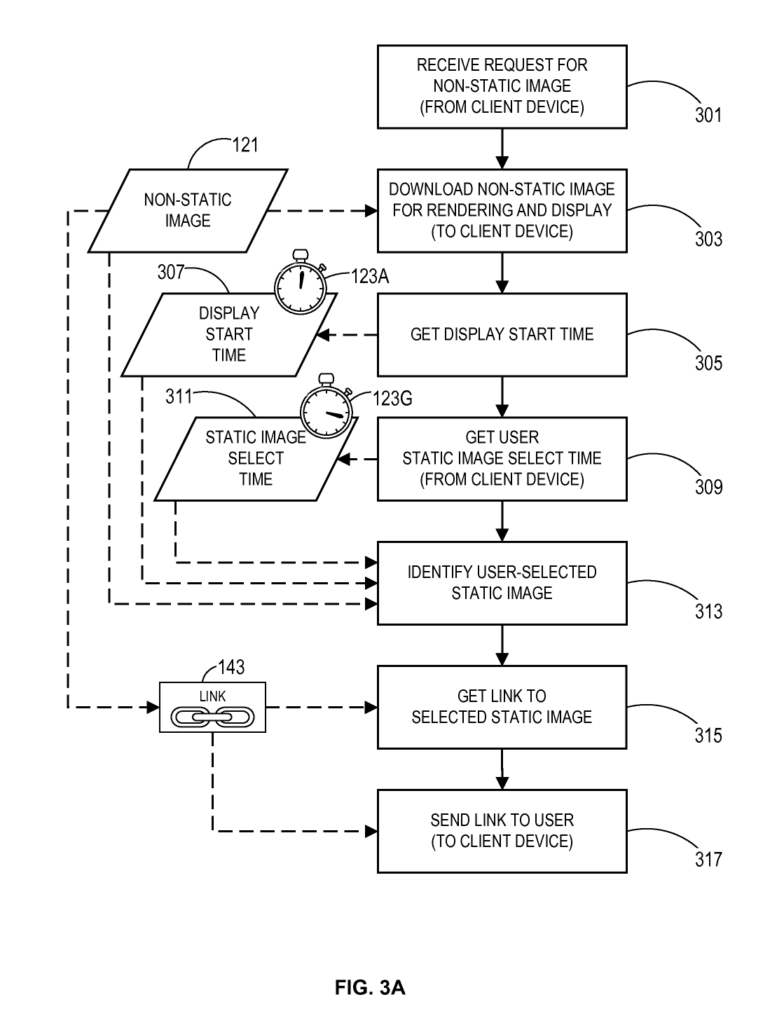

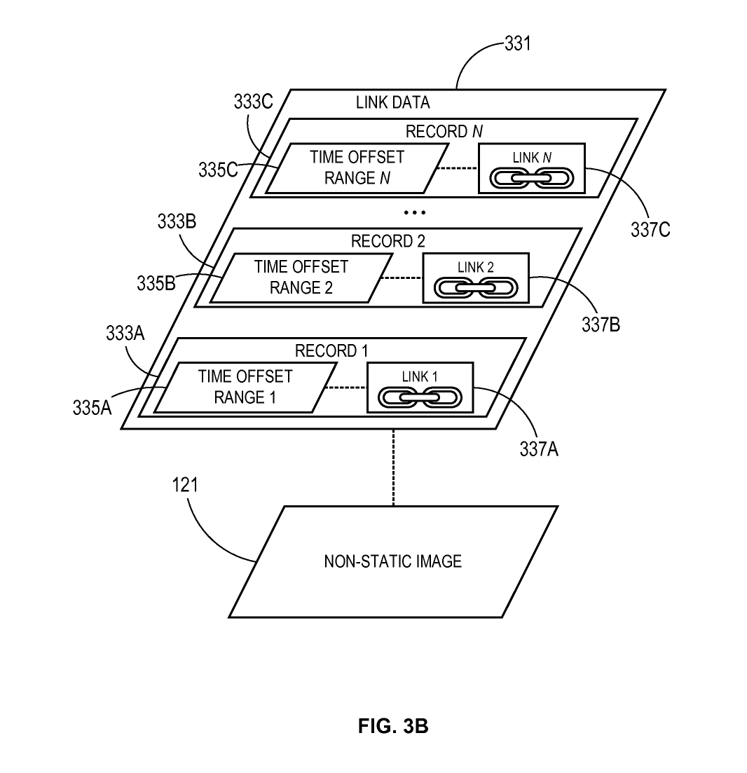

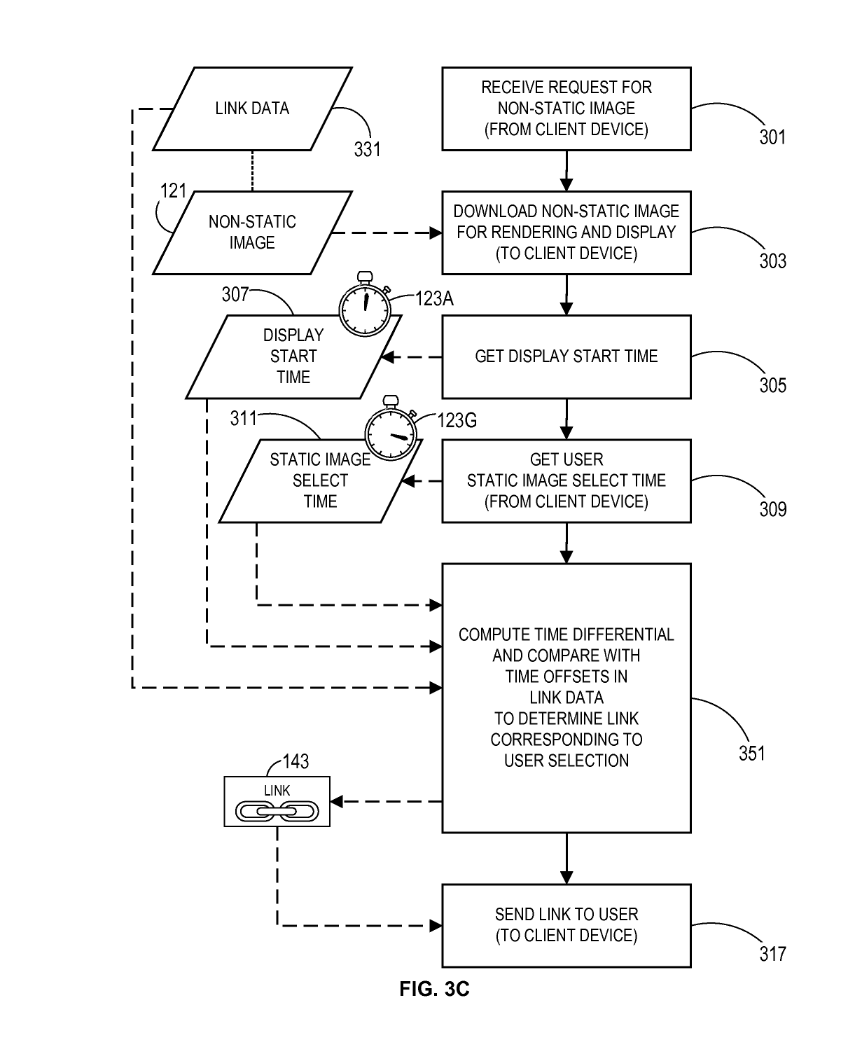

FIG. 3A is a flowchart of a method according to an embodiment of the present invention. In a step 301 a request for a non-static image is received from a client device (such as client device 131 in FIG. 1). In a step 303, non-static image 121 is downloaded for rendering display to the client device. In a step 305 display start time 123A is obtained and put into a start-time storage 307. In a step 309, the user's static image select time is obtained from the client device and stored in a static image select time storage 311. In this non-limiting example, the static image select time coincides with display time 123G, which is the start time of display of selected image 121G. In a step 313, the user-selected static image is identified, based on non-static image 121, display start time 307, and static image select time 311. In a step 315, link 143 to the selected image is obtained, and in a step 317, link 143 is sent to the user via client device 131.

FIG. 3B illustrates a structure 331 for link data, according to an embodiment of the present invention. Link data 331 contains one or more records (shown in the non-limiting example as a first record 333A, a second record 333B, . . . , and an Nth record 333C) that associate links (shown in the non-limiting example as a first link 337A, a second link 337B, . . . , and an Nth link 337C) with respective time offset ranges (shown in the non-limiting example as a first time offset range 335A, a second time offset range 335B, . . . , and an Nth time offset range 335C) that relate each link to a different time segment of the playback of non-static image 121.

According to various embodiments of the present invention, a time offset range is based on one or more time offsets. In a related embodiment, a time offset range specifies both the starting and ending times of a non-static image segment. In another related embodiment, a time offset range is specified by a single offset time, and the range extent is computed according to a previous offset time (or the beginning of the non-static image display if there is no previous offset time) or a subsequent offset time (or the end of the non-static image display if there is no subsequent offset time).

In a further related embodiment, segments may be contiguous in time, but are non-overlapping. In a related embodiment, link data 331 is a data structure within a database.

FIG. 3C illustrates a method according to a related embodiment of the invention. In a non-limiting example, non-static image 121 is a slide-show display of a series of advertisements, offers, and/or other presentations that might be of interest to the viewer. The relative starting times of the slides are stored as time offset ranges 335 in link data 331 (FIG. 3B). Steps 301, 303, 305, 309, and 317; as well as display start time 307 and static image select time 311 are the same as illustrated in FIG. 3A and previously described. However, in this embodiment of the invention, when the viewer indicates a slide of special interest (such as with a click or tap), a step 351 captures the relative time delay from display start time 307 to static image select time 311 and compares the delay against stored offset time ranges 335 (FIG. 3B) to determine that link 143 is the correct link corresponding to the selected image. In a non-limiting example suppose that first time offset range 335A is 3 seconds to 6 seconds, second time offset range 335B is 6 seconds to 9 seconds, and static image select time 311 (FIG. 3B) is 4 seconds after the display of non-static image 121 begins. Thus, the user's image selection is during first offset range 335A, and hence first link 337 is the correct link to use as link 143. In another related embodiment, non-static image 121 is a video or animation, wherein a series of sequential static images is associated with a single link in link data 331—that is, a single link is associated with multiple images which are sequentially shown to the user during the corresponding time offset range in link data 331.

In still another related embodiment, time offset ranges may be separated in time by short gaps, to allow for approximate time measurements to allow for limited precision in measuring time. In a non-limiting example of this embodiment, first time offset range 335A is 3 seconds to 5.5 seconds, second time offset range 335B is 6 seconds to 8.5 seconds, and static image select time 311 is 5.7 seconds after the display of non-static image 121 begins. In this case, static image select time 311 is in the gap between first time offset range 335A and second time offset range 335B. In practice, the transition between the first segment and second segment of non-static image 121 occurs during this gap. The system can decide in real-time how best to determine which segment the user intended, for example, depending on the current network latency. In practice, therefore, time measurements need not be exact.

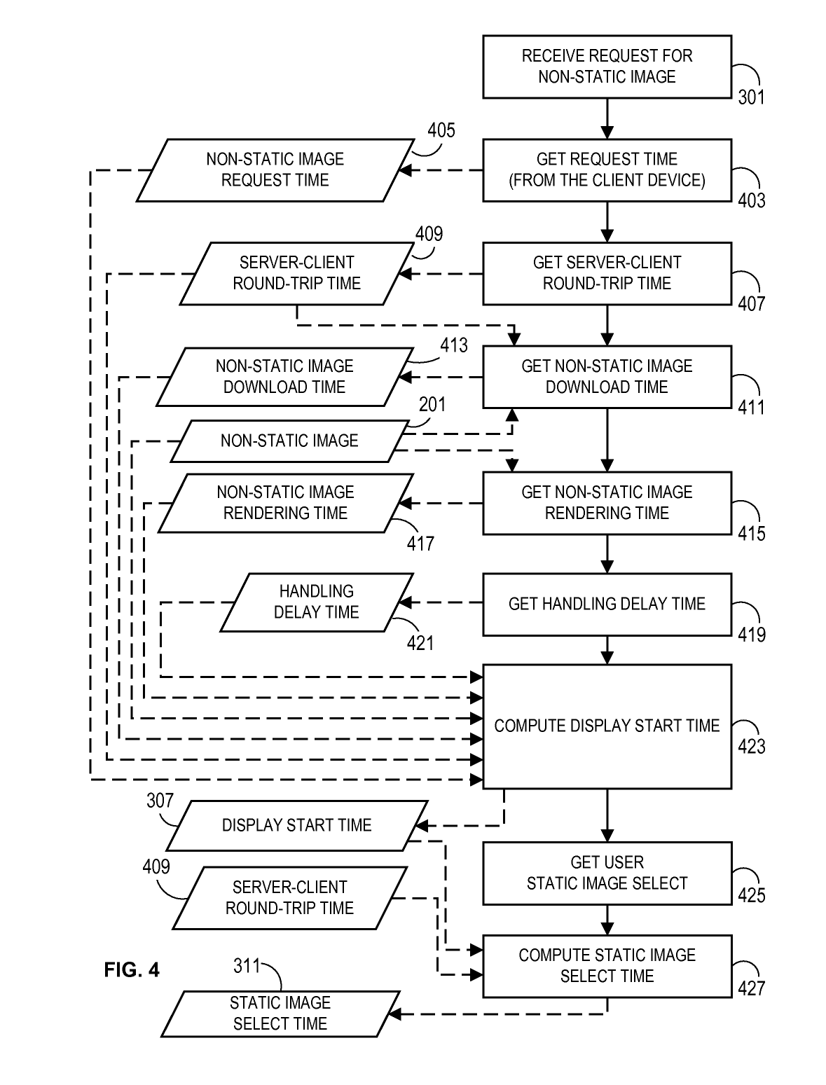

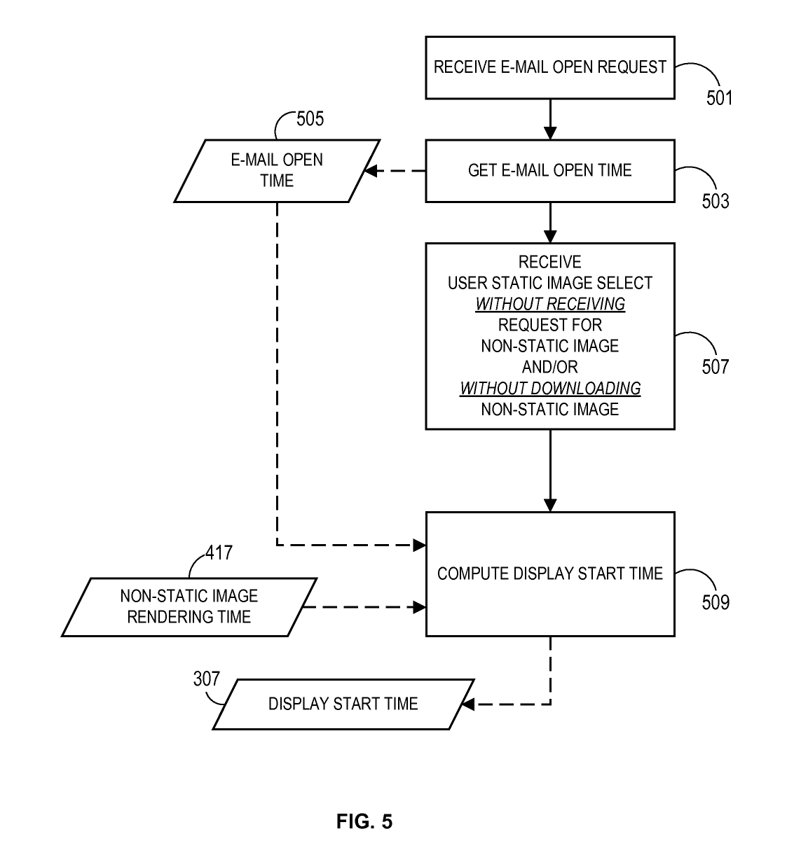

FIG. 4 is a flowchart of an enhancement of the method of FIG. 3A according to another embodiment of the present invention. This enhancement takes into account delay times of transmission, downloading, rendering, caching, and other handling operations (such as the time delays incurred when handling clicks or gestures). A click, for example, can generate a sequence of activities before an actual request is sent to the server. Ideally, such delays should be reported to the server (as a parameter) to include in the calculation that identifies which static image has been selected. Knowledge of the delay time improves accuracy of the method and allows for operation when the non-static image is cached rather than downloaded. The situation of cached non-static images is detailed further in the discussion of FIG. 5, below.

The enhanced method begins with step 301 as previously described. In a step 403, a non-static image request time 405 is obtained and stored. In a step 407 server-client round-trip time duration 409 is measured and stored. Round-trip time duration 409 is the time duration starting at the sending of a packet from the server to the client device until the server receives a response packet from the client device, such as a round-trip time measured by a ping networking utility. In a step 411, knowledge of server-client round-trip time 409 and non-static image 201 is used to get a non-static image download time duration 413. In a step 415, a non-static image rendering time duration 417 is obtained, and in a step 419 a handling delay time duration 421 is obtained. Then, in a step 423, display start time 307 is computed, taking into account non-static image request time 405, server-client round-trip time duration 409, non-static image download time duration 413, non-static image rendering time duration 417, and handling delay time duration 421.

Following the above steps, in a step 425, the user static image select is obtained, after which a step 427 computes static image select time 311, based on display start time 307 and client-server round-trip time 409.

FIG. 5 is a flowchart of a modification of the method of FIG. 3A for cached non-static images according to further embodiments of the present invention. If a click request for a link to a static image being displayed within a non-static image does not have corresponding preceding image request from the client device, it means that the non-static image is served by caching rather than download. Likewise, if a click request for a link to a static image does not have a preceding non-static image download, it also means that the non-static image is served by caching rather than download. As a non-limiting example, the client device might request a non-static image download, but it may be that the client device already has the non-static image stored in cache from a previous download and that the non-static image has not been modified, so that there is no need for another download. In any case, the e-mail open request (or other suitable internal event to the e-mail request) is used as display start time 307.

In a step 501 an e-mail message open request is received, and in a step 503, an e-mail message open time 505 is obtained. In a step 507, a static image select request notification is received without receiving a request for a non-static image and/or without a preceding non-static image download. As noted above, either or both of these conditions indicates that the non-static image is served by caching rather than download, and that the static image select request is without download of a non-static image. Thus, using non-static image rendering time, a step 509 computes display start time 307 for the cached image.

What is claimed is:

1. A method for identifying a static image selected by a user from within a display of a non-static image, the method comprising:
downloading, to a client device, a non-static image containing a plurality of static images;
obtaining a start time of the display of the non-static image;
receiving, from the client device, a notification of a selection, by a user, of a static image from the plurality of static images;
obtaining a time of the static image selection by the user; and
responsively to the obtaining the time of the static image selection, identifying the specific static image selected by the user from the plurality of static images, wherein the identifying is based on the start time of the display of non-static images and the time of the static image selection by the user.

2. The method of claim 1, further comprising sending to the client device a network link to the specific static image selected by the user.

3. The method of claim 1, further comprising directing the client device to a network address associated with the specific static image selected by the user.

4. The method of claim 1, further comprising receiving a request from the client device to display the non-static image.

5. The method of claim 4, further comprising:
obtaining a delay time that includes at least one of:
a server-client device round-trip time duration;
a non-static image download time duration;
a non-static image rendering time duration; and
a handling delay time duration; and
computing the start time of the display according to the delay time.

6. The method of claim 5, further comprising obtaining a request time from the client device, and wherein the computing is further based on the request time.

7. The method of claim 2, wherein identifying the specific static image selected by the user from the plurality of static images is based on a data structure that associates the network link with a time offset.

8. A method for identifying a static image selected by a user from within a display of a non-static image, the method comprising:
receiving an open request from a client device for an e-mail message;
obtaining a time of opening the e-mail message;
receiving, from the client device, a notification of a selection, by a user, of a static image from the plurality of static images without download of a non-static image;
computing a start time of the display of the non-static image based on the time of opening the e-mail message;
obtaining a time of the static image selection by the user; and
responsively to the obtaining the time of the static image selection, identifying the specific static image selected by the user from the plurality of static images, wherein the identifying is based on the start time of the display of non-static images and the time of the static image selection by the user.

9. The method of claim 8, further comprising sending to the client device a network link to the specific static image selected by the user.

10. The method of claim 8, further comprising directing the client device to a network address associated with the specific static image selected by the user.

11. The method of claim 9, wherein identifying the specific static image selected by the user from the plurality of static images is based on a data structure that associates the network link with a time offset.

12. A method for selecting a network link according to a display of a non-static image, the method comprising:
downloading, to a client device, a non-static image;
obtaining a start time of the display of the non-static image;
receiving, from the client device, a selection notification by a user, during the display of the non-static image;
obtaining a time of the selection notification; and
responsively to the obtaining the time of the selection notification, selecting a network link according to a data structure that associates the network link with a time offset corresponding to the time of the selection notification.

13. The method of claim 12, further comprising:
receiving an open request from a client device for an e-mail message; and
obtaining a time of opening the e-mail message;
wherein obtaining a start time of the display of the non-static image is by computing a start time of the display of the non-static image based on the time of opening the e-mail message.
